(19) United States
(12) Patent Application Publication
(10) Pub. No.: US 2026/0101403 A1
(43) Pub. Date: Apr. 9, 2026

(54) SYSTEMS AND METHODS FACILITATING INTERWORKING OF LTE-M DEVICES WITH COMMUNICATION NETWORKS

(71) Applicant: AT&T Mobility II LLC, Atlanta, GA (US)

(72) Inventor: Anthony Dalby, Carrollton, TX (US)

(73) Assignee: AT&T Mobility II LLC, Atlanta, GA (US)

(21) Appl. No.: 18/910,712

(22) Filed: Oct. 9, 2024

(51) Int. Cl. H04W 76/20

(52) U.S. Cl. CPC H04W 76/20

(57) ABSTRACT

Aspects of the subject disclosure may include, for example, connecting, by an interworking system including a processor, an LTE-M device with an access and mobility management function (AMF) of a 5G mobile core network over an N-1 interface, connecting, by the interworking system, an LTE radio with the AMF over a S1 interface and a N2 interface using a next generation application protocol (NGAP), and transferring, by the interworking system, a data traffic from the LTE-M device via a user plane function of the 5G network by terminating a packet data network (PDN) session and reestablishing as a packet data unit (PDU) session. Other embodiments are disclosed.

### FIELD OF THE DISCLOSURE

The subject disclosure relates to systems and methods facilitating interworking of LTE-M devices with communication networks.

### BACKGROUND

Long-Term Evolution Machine Type Communication (LTE-M) is a type of low-power wide-area (LPWA) network radio communication technology standard according to 3GPP for machine-to-machine and Internet of Things (IoT) applications. 3GPP Release 12, Release 13, and Release 14. LTE-M is a technology typically used in Machine-type communication (MTC) or other IoT use cases. LTE-M includes LTE Category 0 (3GPP Release 12) and enhanced Machine Type Communication (eMTC or also known as LTE Cat-M1 and LTE Cat-M2)(3GPP Release 13 and Release 14).

IoT devices are typically deployed in places where Wi-Fi, ethernet, or landlines are inaccessible or unavailable, thereby leaving cellular networks potentially the only connectivity option. To provide cost effective cellular networks, data requirements may be kept low and sent intermittently using the LTE-M standard. LTE-M can be scaled up for a greater number of devices due to its efficient use of spectrum and network resources. There is a need to support LTE-M past LTE sunset. Currently LTE-M devices may not be fully supported on a 5G core platform.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B is a block diagram illustrating an example, non-limiting embodiment of an interworking system in accordance with various aspects described herein.

FIG. 2C illustrates International Mobile Subscriber Identity (IMSI) and Subscription Concealed Identifier in accordance with various aspects provided herein.

FIG. 2D is a block diagram illustrating an example, non-limiting embodiment of a first component of an interworking system in accordance with various aspects described herein.

FIG. 2E is a block diagram illustrating an example, non-limiting embodiment of a second component of an interworking system in accordance with various aspects described herein.

FIG. 2F is a block diagram illustrating an example, non-limiting embodiment of a third component of an interworking system in accordance with various aspects described herein.

FIG. 2G is another block diagram illustrating an example, non-limiting embodiment of a third component of an interworking system in accordance with various aspects described herein.

FIG. 2H depicts an illustrative embodiment of a method in accordance with various aspects described herein.

FIG. 2I depicts an illustrative embodiment of another method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for systems and methods facilitating interworking of LTE-M devices with 5G communication networks. The systems and methods provide an interworking system configured to emulate LTE procedures with respect to LTE-M devices and 5G procedures with respect to the 5G mobile core. For instance, the interworking system is configured to emulate functions of Mobility Management Entity (MME) in LTE on a side facing LTE-M devices and functions of Access and Mobility Management (AMF) in 5G on a side facing the 5G mobile core. As another example, the interworking system is further configured to receive an LTE-M device identifier and switch to a 5G identifier. One or more of the components and/or functions described herein can be utilized with other communication networks which may operate in next generation or higher generation communication networks than 5G communication networks. Other embodiments are described in the subject disclosure.

One or more aspects of the subject disclosure are directed to a device including a processing system having a processor and a memory that stores executable instructions that, when executed by the processing system, facilitate performance of operations. The operations include, with a first component, connecting an LTE-M device with an access and mobility management function (AMF) of a 5G mobile core network over an N-1 interface; with a second component, connecting an LTE radio with the AMF over a S1 interface and a N2 interface using a next generation application protocol (NGAP); and with a third component, transferring a data traffic from the LTE-M device via a user plane function (UPF) of the 5G network by terminating a packet data network (PDN) session and reestablishing as a packet data unit (PDU) session.

One or more aspects of the subject disclosure are directed to a non-transitory machine-readable medium, comprising executable instructions that, when executed by a processing system including a processor, facilitate performance of operations. The operations include connecting, via a first component, an LTE-M device with an access and mobility management function (AMF) of a 5G mobile core network over an N-1 interface; connecting, via a second component, an LTE radio with the AMF over a S1 interface and a N2 interface using a next generation application protocol (NGAP); and transferring, via a third component, a data traffic from the LTE-M device via a user plane function of the 5G network by terminating a packet data network (PDN) session and reestablishing as a packet data unit (PDU) session.

One or more aspects of the subject disclosure are directed to a method including connecting, by an interworking system including a processor, an LTE-M device with an access and mobility management function (AMF) of a 5G mobile core network over an N-1 interface, connecting, by the interworking system, an LTE radio with the AMF over a S1 interface and a N2 interface using a next generation application protocol (NGAP), and transferring, by the interworking system, a data traffic from the LTE-M device via a user plane function of the 5G network by terminating a packet data network (PDN) session and reestablishing as a packet data unit (PDU) session.

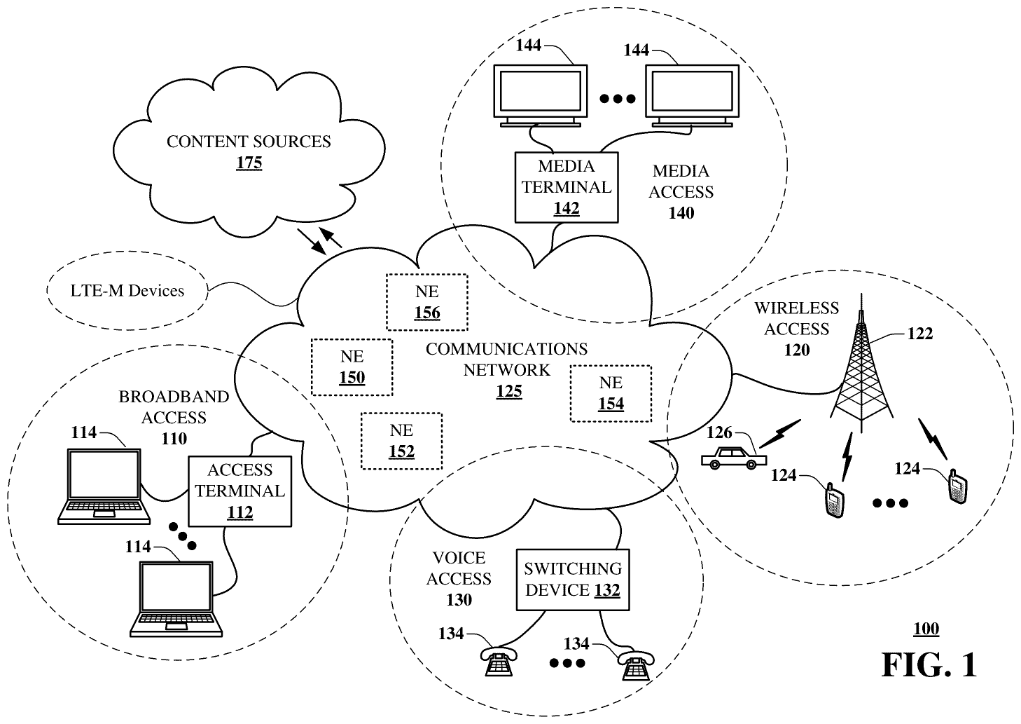

Referring now to FIG. 1, a block diagram is shown illustrating an example, non-limiting embodiment of a system 100 in accordance with various aspects described herein. For example, system 100 can facilitate in whole or in part systems and methods facilitating interworking of LTE-M devices with 5G communication networks. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

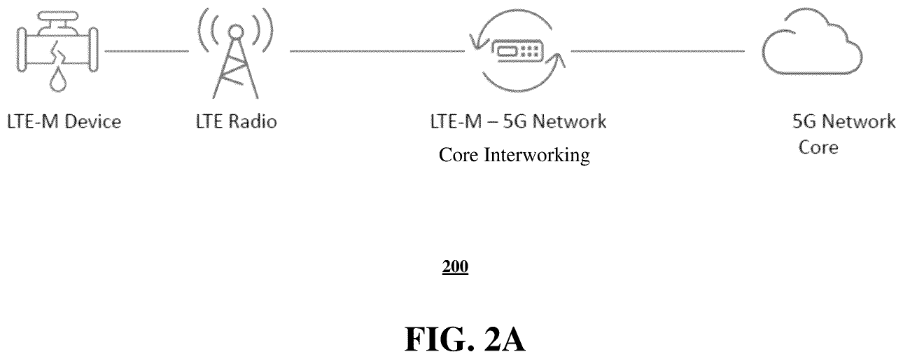

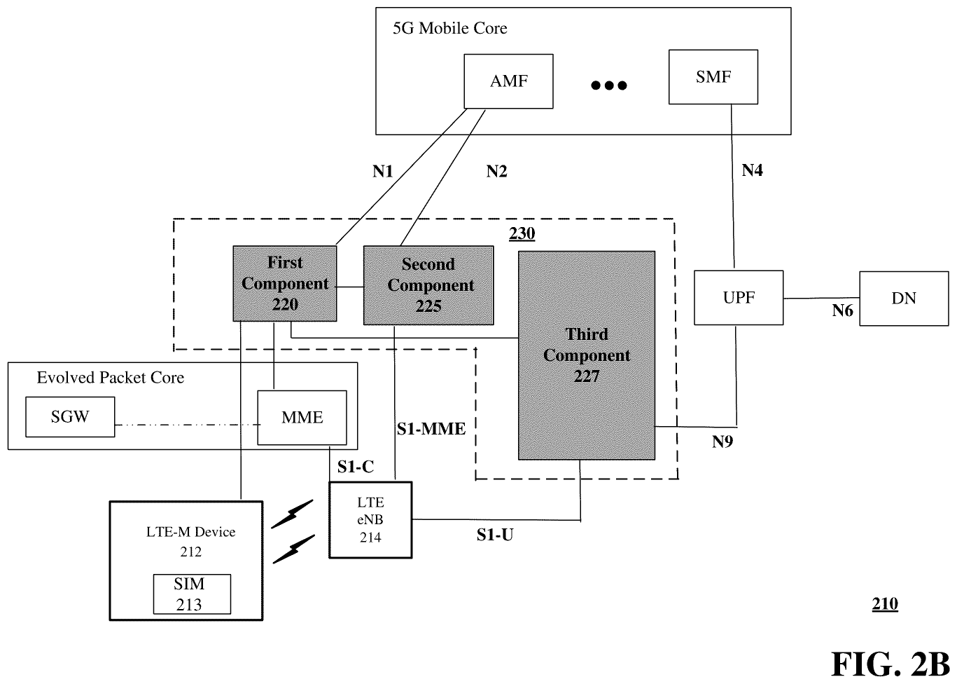

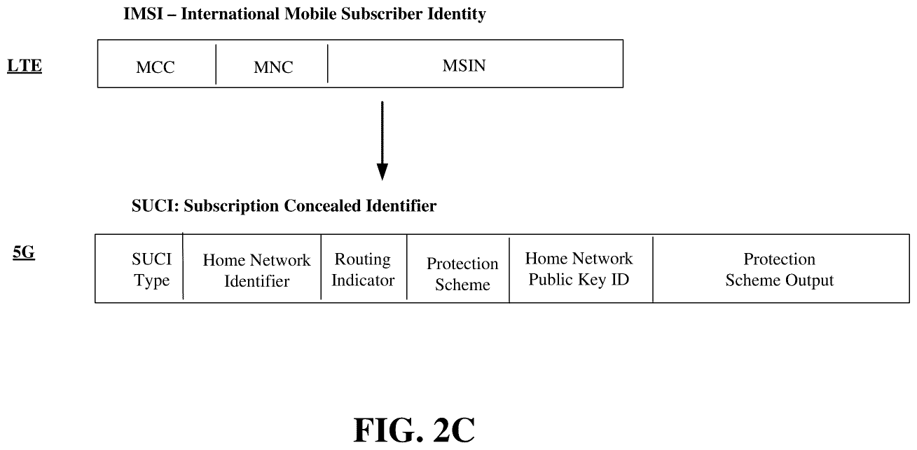

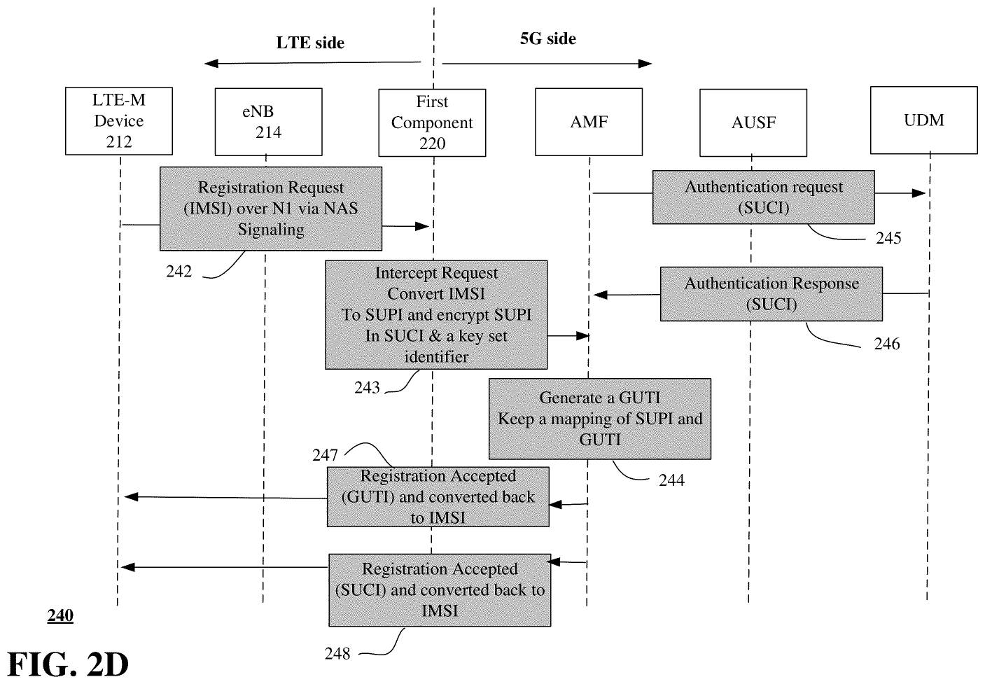

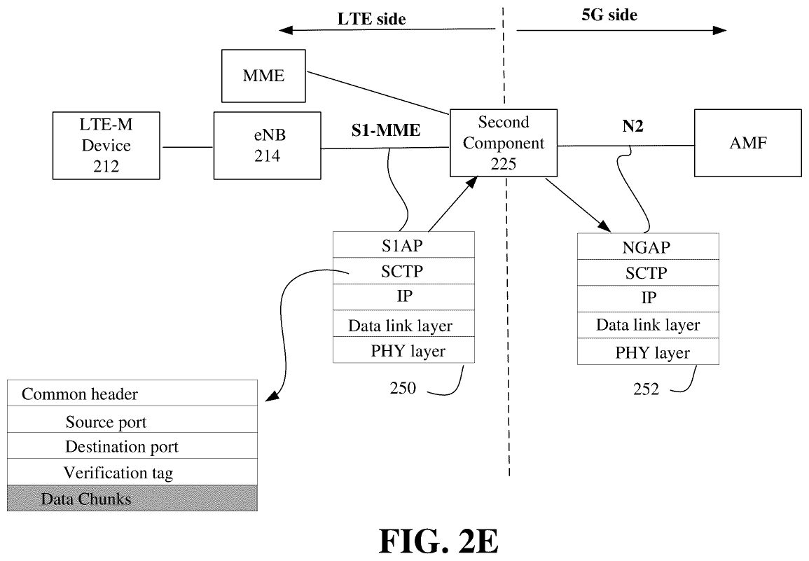

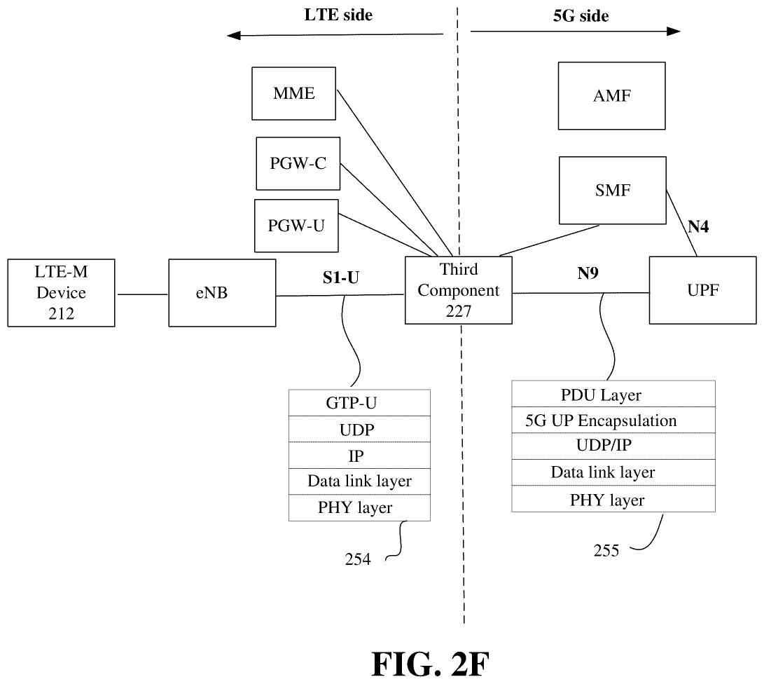

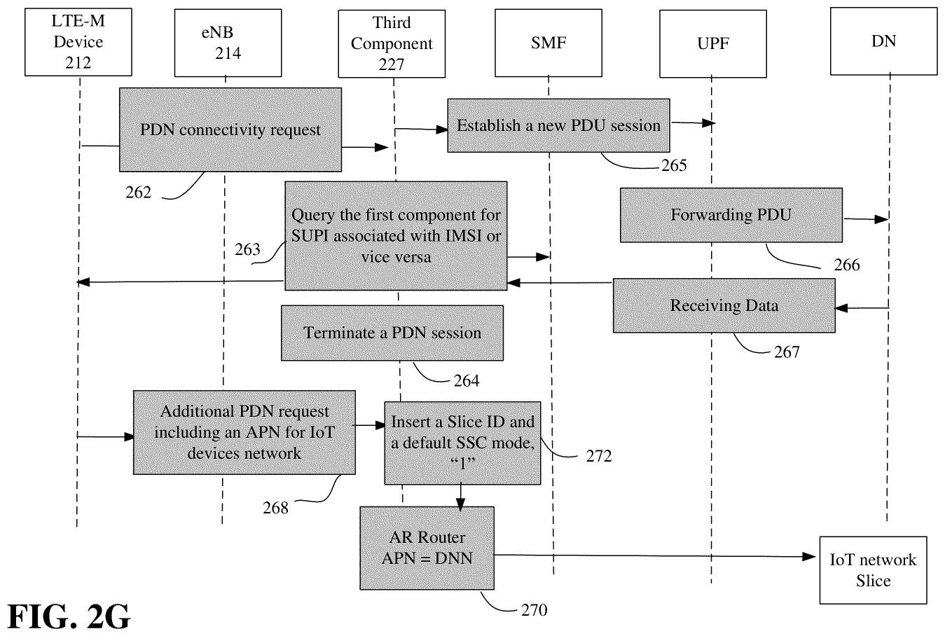

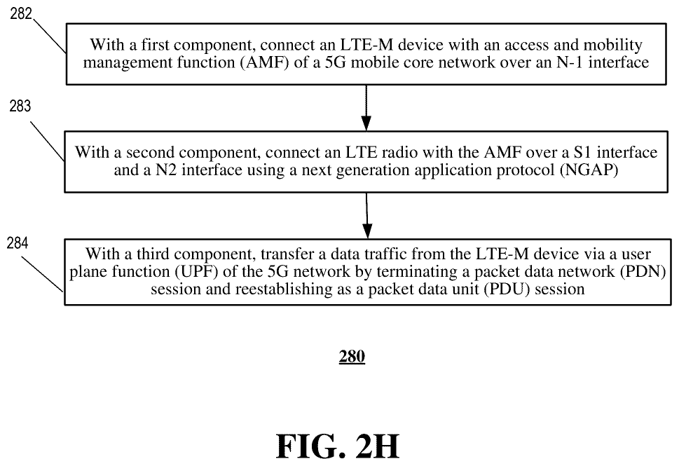

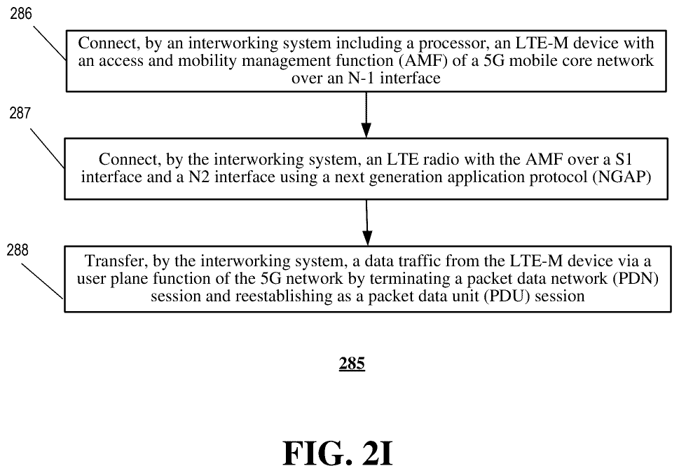

FIG. 2A is a block diagram illustrating an example, non-limiting embodiment of a system 200 functioning within the communication network of FIG. 1 in accordance with various aspects described herein. In various embodiments, the system 200 includes LTE-M devices such as a water meter which are connected to LTE radio networks. LTE-M devices are ultimately connected to 5G network core by using LTE-M to 5G network core interworking.

LTE-M may play a vital role in 5G communication networks to support low power wide area (LPWA) use cases. LTE-M provides global coverage and mobility. Moreover, LTE-M can reduce battery consumption and improve indoor coverage. LTE-M supports lower device complexity, extended battery life, and better coverage, making it ideal for use cases like asset tracking and smart metering. LTE-M offers a data rate of 1 Mbps for 3GPP Release 13, rising to 4 Mbps for Release 14, greater mobility and voice capability over the network.

LTE-M supports power saving mode (PSM) and extended Discontinuous Reception (eDRX), which allow devices to sleep for extended periods of time and wake up only when needed to transmit data. This is critical for IoT devices that need to operate on a small battery for a long period of time. LTE-M supports lower mobility speeds, as opposed to LTE designed for high-speed mobility.

LTE-M, when operating in LTE networks, utilizes Evolved Packet Core (EPC) as a core network that manages functions for the LTE network, including authentication, session management, mobility management, and routing of data to external networks. LTE-M uses a modified version of LTE radio protocols. It operates in licensed spectrum with a bandwidth as low as 1.4 MHz (cf. 20 MHz for regular LTE). This narrower bandwidth is sufficient for a small amount of data typically sent by IoT devices. LTE-M can support voice communication over the LTE network using Voice over LTE (VoLTE), which can be important for certain IoT applications such as alarm systems or emergency services.

LTE-M and bandwidth-reduced low-complexity UEs are collectively referred to as LTE-M devices in accordance with various aspects described herein. Many IoT devices are operating as LTE-M devices as they are designed to utilize lower processing power, memory and hardware requirements for use over long periods of time. LTE-M devices may be typically deployed in places where Wi-Fi, ethernet, or landlines are inaccessible, leaving cellular potentially the only connectivity option. As cellular data may be costly, data requirements of LTE-M devices may be kept low, and send intermittently. To get online with LTE-M devices, a Subscriber Identity Module (SIM) card may be required that operates on 5G networks. LTE-M devices use a single antenna for communication, which is less complex than multiple antennas used for Multiple Input Multiple Output (MIMO) in standard LTE.

In the LTE network, LTE-M devices communicate with Mobility Management Entity (MME) which is a component of the EPC that handles signaling and control functions, including UE authentication and security. LTE Radio access network nodes (eNodeBs or eNBs) communicate with Serving Gateway (SGW) that routes and forwards user data packets, while also acting as the mobility anchor for data bearers when user equipment (UE) moves between eNodeBs and Packet Data Network Gateway (PGW). PGW connects the LTE network to external IP networks, providing UEs with IP addresses and Quality of Service (QoS) management.

FIG. 2B is a block diagram illustrating an example, non-limiting embodiment of a system 210 in accordance with various aspects described herein. In various embodiments, In various embodiments, the system 210 is configured to connect an LTE-M device 212 to 5G communication networks. The LTE-M device 212 includes various types of IoT devices, such as a water meter. The LTE-M device 212 can operate in LTE communication networks. In that case, the LTE device 212 powers up and needs to connect to the LTE networks to obtain a service. The LTE device 212 attaches to an eNodeB (eNB) and Mobility Management Entity (MME) that serves the eNB prior to establishing a session and data connection with a network gateway and an application server.

In LTE communication networks, the LTE-M device 212 attaches to an LTE eNB 214 which is connected to MME via a S1 interface. The S1 interface allows for the exchange of data and control signals between the eNB and Evolved Packet Core (EPC), and performs functions such as mobility management, security, bearer management, etc. The mobility management function tracks the location and movement of the LTE-M device 212. The security function encrypts and authenticates communication between the eNB 214 and MME. The bearer management function establishes, modifies, and releases bearers, which are local channels that carry traffic with a specific quality of service (QoS).

In various embodiments, the system 210 includes an interworking system 230. As depicted in FIG. 2B, the LTE-M device 212 is connected to a 5G mobile core using the interworking system 230. The 5G mobile core includes examples of network functions provided by, or included, in a control plane which include an access mobility function (AMF) configured to facilitate mobility management in a control plane of the network system (including, for instance, providing UE mobility information associated with the access network(s) and/or user equipment to the control plane). The 5G mobile core further includes a Session Management Function (SMF) which is responsible for managing sessions between user devices and the 5G network. The SMF is configured to perform session management by setting up, modifying, and terminating sessions, ensuring that end-to-end communication is available, IP address allocation by allocating and managing IP addresses for user elements, policy enforcement by receiving and converting Policy and Charging Control (PCC) rules into Quality of Service (QoS) rules, profiles, and templates for user equipment, base stations, and user plane function (UPF). The SMF is further configured to perform QoS control, usage data collection, and network slicing, etc. The 5G mobile core include other network functions and detailed description as to other network functions are omitted.

In various embodiments, the interworking system 230 includes a first component 220 interfacing the LTE-M device 212 and the 5G mobile core. A second component 225 interfaces, for control signaling, the LTE eNB 214 and the 5G mobile core. A third component 227 interfaces, for transferring data traffic, the LTE eNB 214 and the 5G mobile core. For instance, the interworking system 230 interfaces and connects the LTE-M device 212 and the LTE eNB 214 with the 5G mobile core, as depicted in FIG. 2B. The first component 220 is arranged over an N1 interface, and the second component 224 is over a N2/S1-MME interface. The third component 227 is over a N9/S1-U interface. For instance, the first component 220, the second component 224, and the third component 227 are configured to implement and emulate software defined network functions of LTE and 5G communication networks. The interworking system 230 resides in the 5G networks, which can be located in a data center, a cloud such as an edge cloud, a virtual cloud, etc.

In various embodiments, the interworking system 230 is configured to emulate LTE network functions on a side facing the LTE-M device 212 and 5G network functions on the other side facing the 5G mobile core. For instance, the interworking system 230 is configured to emulate the functions of MME on the side facing the LTE-M device 212 and emulate the functions of the AMF on the side facing the 5G networks.

In various embodiments, the LTE-M device 212 is connected to the AMF via the first component 220 over an N1 interface. The N1 interface is an interface between user equipment (UE) including the LTE-M device 212 and the AMF in the 5G communication networks, and most of non-access stratum (NAS) signaling is going through the N1 interface. NAS is a functional layer running between the UE and the 5G mobile core and responsible for establishing, maintaining, and releasing sessions between the UE and the 5G mobile core. NAS is responsible for tasks related to control and support of the UE. NAS ensures that the UE maintains connectivity and active sessions as the UE moves. NAS handles tracking the UE's location, handovers between calls, and managing mobility-related events. NAS establishes, maintains, and terminates communication links. NAS handles authentication and authorization and verifies the UE's identity during network attachment and ensures secure communication. Examples of NAS messages include update or attach messages, authentication messages, service requests, etc. In some cases, some network carriers may prefer to deliver short message service (SMS) over the NAS layer. In order for SMS to work over NAS, NAS requires the UE to perform a combined EPS (Evolved Packet System) and IMSI (International Mobile Subscriber Identity) attachment. SMS messages in an encapsulated form are transferred between the UE and the network.

In various embodiments, as SMS over NAS is delivered, registration information of the LTE-M device 212 is delivered via NAS signaling over the N1 interface. Several security procedures may need to be done on both sides of the N1 interface. On the LTE side, a SIM 213 of the LTE-M device 212 is configured as a record holder for security keys which are necessary for the registration. The MME is responsible for authentication of the SIM 213 in the LTE-M device 212. On the 5G side, the first component 220 includes a database storing a profile corresponding to the LTE-M device 212. For instance, the first component 220 is configured to serve as an eSIM or embedded SIM or virtual SIM which store multiple profiles. The first component 220 is arranged and configured to hold keys that are assigned to a particular LTE IMSI. A registration procedure of the LTE-M device 212 may emulate, with the LTE to 5G network functions properly laid out, such as MME v. AMF. Through the first component 220, the AMF can recognize the LTE-M device 212.

FIG. 2C illustrates International Mobile Subscriber Identity (IMSI) and Subscription Concealed Identifier (SUCI) in accordance with various aspects provided herein. Up to 4G LTE, an IMSI has been used as a unique identifier, which has been replaced by Subscription Permanent Identifier (SUPI) for the 5G. As authentication between a user equipment and a network provider is based on a shared symmetric key, the authentication can take place after UE identification. A SIM card of a UE is assigned with a temporary subscriber identifier by the network that the UE has visited for privacy and security concern. In some cases, however, the use of temporary identifiers may not be available. Plain text transmissions of the SUPI over radio is not allowed in the 5G networks, and instead, a concealed SUPI is transmitted as Subscription Concealed Identifier (SUCI).

FIG. 2C depicts data fields of IMSI and SUCI, respectively. A valid SUPI includes an IMSI or a network access identifier (NAI) and is usually a string of 15 decimal digits of Mobile Country Code (MCC), Mobile Network Code (MNC) identifying a network operator, and Mobile Subscriber Identification Number (MSIN) representing an individual user of a particular network operator, as depicted in FIG. 2C. SUCI preserves privacy containing the concealed SUPI. The UE generates a SUCI using a public key of Home Network that was securely provisioned to the USIM during the USIM registration, as depicted in FIG. 2C. For the SUCI type field, IMSI corresponds to “0” and NAI corresponds to “1.” When the SUPI type is an IMSI, the Home Network Identifier corresponds to MCC and MNC. When the SUPI type is a NAI, the Home Network Identifier corresponds to a string of characters representing a domain name. The protection scheme identifier includes a value representing Profile A and Profile B. The home network public key identifier represents a public key provisioned by the Home Public Land Mobile Network (HPLMN) and it is used to identify the key used for SUPI protection.

In various embodiments, the first component 220 includes a registry of SUPIs that are associated with IMSI of LTE-M devices. The first component 220 then may encrypt a SUPI to a SUCI to be used for authentication and following 5G procedures. The first component 220 is further configured to emulate the LTE network functions on the side facing the LTE-M device 212 and emulate the 5G network functions on the side facing the 5G networks.

FIG. 2D is a block diagram illustrating an example, non-limiting embodiment of a first component of an interworking system in accordance with various aspects described herein. In various embodiments, when the LTE-M device 212 registers a first time, the LTE-M device 212 sends a registration request message including an IMSI over the N1 interface (Flow 242). The registration request message is sent via NAS signaling. The registration request message is received and intercepted by the first component 220 (242). The first component 220 includes profiles or registries of LTE devices including the LTE-M device 212. Referring back to FIG. 2C, the profiles of LTE devices may be stored in a form of a SUPI along with the associated or corresponding IMSI. For the LTE-M device 212, the SUCI type is stored as “0” to indicate the IMSI and the Home Network Identifier corresponds to MCC and MNC.

In various embodiments, the first component 220 intercepts the registration request from the LTE-M device 212 and converts the IMSI to the SUPI and encrypts the SUPI in the SUCI (243). A key set identifier (ngKSI) assigned to the LTE-M device 212 is contained in the profile for the LTE-M device 212. The ngKSI may be provided from a 5G SIM provider. The ngKSI is a unique identifier assigned to each user device (UE) in a 5G network and used during the registration process and authentication procedures between the UE and the 5G core network. The ngKSI plays a crucial role in identifying and managing security keys used for encrypting and decrypting communication between devices within the network. The ngKSI helps establish secure communication channels by ensuring that the correct security context is used.

The ngKSI includes three parts of Home Network Identifier (HNID), Slide Identifier (SI), and Key Set Identifier (KSI). The HNID Identifies the home network where the LTE-M device 212 is registered (e.g., MCC and MNC). The SI identifies a specific network slice to which the UE belongs (network slicing is a key feature in 5G). The KSI indicates the type of security context associated with the UE. The ngKSI ensures that the right set of keys (such as encryption keys, integrity protection keys, etc.) are applied during data transmission.

The security parameters for authentication, integrity protection and ciphering are tied together in a 5G NAS security context and identified by the ngKSI. Before security can be activated, the AMF, the LTE-M device 212 and the first component 220 need to establish a 5G NAS security context. Usually, the 5G NAS security context is created as the result of a primary authentication and key agreement procedure between the AMF and a UE.

Referring to FIG. 2D, in response to receiving the SUCI for the LTE-M device 212, the AMF generates a temporary identifier (GUTI) and keeps a mapping of SUPI and GUTI (244). Then AMF requests authentication of SUCI to Authentication Server Function (AUSF) and Unified Data Management (UDM) (245). AUSF is responsible for verifying the identity of a subscriber, validating their subscription data, and determining appropriate security context for a subscriber. UDM manages network user data in a single, centralized element, similar to Home Subscriber Service (HSS). AUSF and UDM send an authentication response back to AMF (246). The LTE-M device 212 receives registration acceptance responses for GUTI and SUCI (247, 248) via NAS signaling. The first component 220 is configured to find the IMSI of the LTE-M device 212 corresponding to the GUTI and SUCI (247, 248).

In various embodiments, the first component 220 is configured to emulate the registration and authentication functions performed by the MME on the LTE side and the AMF on the 5G side, as depicted in FIG. 2D. The first component 220 is configured to emulate certain functions done by the MME to send the registration request from the LTE-M device 212 and perform necessary security procedures. Additionally, the first component 220 is further configured to emulate certain functions done by the AMF to authenticate the LTE-M device 212 and perform necessary security procedures required in the 5G networks.

FIG. 2E is a block diagram illustrating an example, non-limiting embodiment of operations of the second component 225 in accordance with various aspects described herein. In various embodiment, the interworking platform 230 includes the second component 225 which interfaces a S1 interface and a N2 interface, as depicted in FIGS. 2B and 2E. The S1 interface in LTE is generally used between eNodeBs and the EPC. In particular, the second component 225 interfaces S1-MME (LTE) and the N2 interface (5G). The S1-MME interface is responsible for delivering signaling protocols between the eNodeB and MME. The S1-MME is responsible for Evolved Packet System (EPS) bearer setup/release procedures, handover signaling procedures, paging procedures and NAS transport procedures.

FIG. 2E depicts a protocol stack 250 over the S1-MME interface. The protocol stack 250 includes a physical layer, a data link layer, and an IP layer. Over the IP layer, the protocol stack 250 includes a Stream Control Transmission Protocol (SCTP) over IP which supports multiple UEs through a single SCTP association. An LTE transport network layer is built on IP transport, similar to the user plane but for the reliable transport of signaling messages, SCTP is added on top of the IP protocol. It also provides guaranteed data delivery. The application signaling protocol is an S1AP (Application Protocol) on the SCTP layer, as depicted in FIG. 2E. S1AP is a signaling protocol used in LTE and 5G wireless networks. It operates between the eNodeB and the MME to establish and maintain the connection between the UE and the core network.

In various embodiments, the N2 interface is a control plane interface that connects 5G radio, i.e., gNodeBs (gNBs) to AMF in the 5G mobile core. FIG. 2E depicts a protocol stack 252 over the N2 interface. The protocol stack 252 includes a physical layer, a data link layer, an IP layer and a SCTP layer. In the N2 interface, a next generation application protocol (NGAP) is on the SCTP layer. NGAP is a protocol that enables communication between the radio access network (RAN) and the core network in 5G. NGAP provides a transport function between the UE and AMF and supports a variety of services, including configuration updates, UE context transfer, PDU session resource management, mobility procedures, connected Mode idle and connected operations. NGAP provides the transport function between UE and AMF by offering NAS signaling transport. Some differences between NGAP and S1AP is that S1AP was designed only for 3GPP access (E-UTRAN) and not non-3GPP accesses. NGAP is applicable to any access.

In various embodiments, the second component 225 is configured to intercept the S1 MME signaling and put it under a NGAP wrapper and send over to AMF. As the S1 MME signaling is transported over the SCTP, the NGAP, working on the SCTP, wraps such signaling before being sent to AMF. The S1-MME interface is responsible for managing UE mobility, session establishment, and overall control of the LTE network. Each of these functions may be emulated on the 5G side to the AMF. The MME is also responsible for authentication of the SIM in LTE. In 5G, the equivalent SIM profile would be used to authenticate the device on the AMF, as described above in connection with FIGS. 2B through 2D. As stated, the MME is also responsible for resource management. It facilitates the establishment and release of bearers based on the device data needs. The second component 225 handles information relating to the MME such as a registration location with the last object location request, etc. with respect to the LTE side. At the same time, the second component 225 is configured to emulate the functions performed by the AMF over the N2 interface.

FIG. 2F is a block diagram illustrating an example, non-limiting embodiment of operations of the third component 227 in accordance with various aspects described herein. In various embodiments, the first and the second components 220 and 225 handle control signaling, and the third component 227 handles data flow. In the user plane, the S1 interface includes S1-U (user plane). The S1 user plane external interface (S1-U) is defined between the LTE eNodeB and the LTE S-GW. The S1-U interface provides non-guaranteed data delivery of LTE user plane Protocol Data Units (PDUs) between the eNodeB and the S-GW. As depicted in FIG. 2F, a protocol stack 254 over the S1-U interface includes a physical layer, a data link layer, an IP layer, a user data plane layer, and a General Packet Radio Service (GPRS) Tunnelling Protocol User Plane (GTP-U) layer. GTP-U is a part of the GTP, which is a group of IP-based communications protocols used to carry general packet radio service (GPRS) within GSM, UMTS, LTE and 5G NR radio networks. GTP-U is used to transport user data between the radio access network and the core network, and within the GPRS core network.

In various embodiments, GTP-U Tunnels are used to carry encapsulated Packet Data Units (PDUs) and signaling messages between a given pair of GTP-U Tunnel Endpoints. The Tunnel Endpoint ID (TEID) which is present in the GTP header indicates which tunnel a particular PDU belongs to. The transport bearer is identified by the GTP-U TEID and the IP address (source TEID, destination TEID, source IP address, destination IP address).

In various embodiments, in order to get a PDU session which is equivalent to a PDN session, an identifier of SUCI needs to be used in the 5G relevant profile. So the 5G SIM profile may need to be used. The third component 227 receives the S1-U signaling and is configured to terminate a LTE packet data network (PDN) session. The third component 227 performs the PDN session termination with respect to every bearer associated with a particular IMSI. The third component 227 is configured to reestablish a packet data unit (PDU) session on the 5G side. The payload will be encapsulated according to the 5G standards. This may solve the issue with exposing the encrypted GTP tunnel. This may mean that the third component 227 will terminate the LTE traffic flow and reestablish the traffic for the 5G networks.

FIG. 2G illustrates an example, non-limiting embodiment of user data traffic using the third component 227 in accordance with various aspects described herein. In various embodiments, the LTE-M device 212 sends a PDN connectivity request via the third component 227 (262). The third component 227 intercepts the PDN connectivity request and queries the first component 220 to identify a SUPI associated with the IMSI of the LTE-M device 212 (263). The first component 220 may need to unencrypt a SUCI to find the SUPI. As described above, the first component 220 stores a registry of SUPIs corresponding to IMSIs of LTE-M devices and is configured to perform encryption/decryption of SUPIs to SUCIs and vice versa. With respect to every PDN bearer, the third component 227 is configured to terminate a PDN session (264). Subsequently, the third component 227 is configured to emulate a process of establishing a new PDU session with the SMF (265). The new PDU session is connected with the Data Network (DN) via the user plane function (UPF) which is responsible for packing routing and forwarding, packet inspection, QoS management, etc. Data received from the data network is provided to the LTE-M device 212 via the UPF and the third component 227 (263, 267). The third component 227 queries the first component 220 to identify the IMSI corresponding to the SUPI and the received data is sent to the LTE-M device 212.

Alternatively, or additionally, a network slice can be used in the 5G networks. Network slicing for IoT devices may be used to be optimized for power consumption and high-density devices. In the 5G networks, data network name (DNN) is used to identify external data networks that 5G devices connect to, and DNN is similar to Access Point Name (APN) used in LTE networks. DNN is used to identify and route traffic to a specific network slice, which is customized with specific QoS requirements for different services and applications. With respect to LTE-M devices, APN and DNN can be used to identify and route traffic from the LTE-M device 212 to a specific network slice of IoT devices and applications. When a UE is using a DNN, it includes the data network name (equivalent to APN) and the network slice identifier. The LTE network simply ignores the 5G components of the DNN such as the slice identifier. Therefore, the APN and DNN name would need to be the same.

A DNN on an area router (AR) can be configured so that the AR router accesses the corresponding data network. An external data network is identified by a DNN on the 5G network, but it can be configured with an APN on the LTE networks. Therefore, the AR router can be configured with APNs and matching or corresponding DNNs (270), as depicted in FIG. 2G. The LTE-M device 212 sends an additional PDN request including an APN for an IoT devices network (268). The third component may insert a default Slice ID for IoT devices as well as a SSC mode value which would always be set to 1 (272). The APN name will act as the Data Network Name portion of the DNN. The request may be sent to the AR router which can provide a corresponding DNN, thereby routing the additional PDN request to an IoT network slice via the SMF and the UPF.

The embodiments described above may avoid having to use a third party hosted solution, or host a dedicated LTE EPC. This may be more costly than having some sort of interworking function. The systems and methods described in the above embodiments may implement the LTE-M to 5G Network core interworking functions which can translate LTE S1-C/U traffic to a 5G control signaling and 5G data flow, thereby providing cost effective mechanism.

FIG. 2H depicts an illustrative embodiment of a method 280 in accordance with various aspects described herein. In various embodiments, the method 280 includes, with a first component, connecting an LTE-M device with an access and mobility management function (AMF) of a 5G mobile core network over an N-1 interface (Step 282); with a second component, connecting an LTE radio with the AMF over a S1 interface and a N2 interface using a next generation application protocol (NGAP) (Step 283); and with a third component, transferring a data traffic from the LTE-M device via a user plane function (UPF) of the 5G network by terminating a packet data network (PDN) session and reestablishing as a packet data unit (PDU) session (Step 284).

In various embodiments, with the first component, the connecting the LTE-M device further includes configuring the first component to emulate a set of functions of a mobility management entity (MME) in communicating with the LTE-M device and emulate another set of functions of the AMF in communicating with the AMF. The emulating the set of functions of the MME further includes sending a registration request including an international mobile subscriber identity (IMSI) of the LTE-M device via non-access stratum (NAS) signaling. The emulating another set of functions of the AMF further includes intercepting the registration request and detecting the IMSI of the LTE-M device, determining a subscription permanent identifier (SUPI) corresponding to the IMSI of the LTE-M device, and encrypting the SUPI to a subscription concealed identifier (SUCI).

In various embodiments, with the second component, the connecting the LTE radio with the AMF further comprise configuring the second component to process control signaling transmitted via a set of protocols over the S1 control (S1-MME) interface to be transmitted using another set of protocols including the NAGP over the N2 interface. The second component is configured to process the control signaling transmitted via SCTP to be wrapped with the NAGP to be transmitted over the N2 interface. With the third component, the transferring the data traffic further comprise configuring the third component to use a set of protocols over the S1 user data (S1-U) interface including a GTP-U and use another set of protocols including a 5G encapsulation protocol over the N9 interface. The method 280 further includes, with the third component, querying the first component to obtain a subscription permanent identifier (SUPI) corresponding to the IMSI of the LTE-M device. The configuring the third component further comprise configuring the third component to terminate a GTP-U session and reestablish a packet data unit (PDU) session.

FIG. 2I depicts an illustrative embodiment of a method 285 in accordance with various aspects described herein. In various embodiments, the method 285 includes connecting, by an interworking system including a processor, an LTE-M device with an access and mobility management function (AMF) of a 5G mobile core network over an N-1 interface (Step 286), connecting, by the interworking system, an LTE radio with the AMF over a S1 interface and a N2 interface using a next generation application protocol (NGAP) (Step 287), and transferring, by the interworking system, a data traffic from the LTE-M device via a user plane function of the 5G network by terminating a packet data network (PDN) session and reestablishing as a packet data unit (PDU) session (Step 288).

In various embodiments, the connecting the LTE-M device with the AMF further includes receiving a registration message from a LTE-M device over an N1 interface, and intercepting the registration message and detecting an international mobile subscriber identity (IMSI) identifier of the LTE-M device. The connecting the LTE-M device with the AMF further includes determining a subscription permanent identifier (SUPI) corresponding to the IMSI identifier of the LTE-M device, and encrypting the SUPI to a subscription concealed identifier (SUCI). The connecting the LTE radio with the AMF further includes wrapping a stream control transmission protocol packet with the NGAP, and transmitting the NGAP wrapped packet over the N2 interface. The transferring the data traffic further includes receiving the data traffic encapsulated by a GTP packet in the PDN session prior to the termination. The transferring the data traffic further includes, in the reestablished PDU session, transmitting the data traffic encapsulated according to a 5G standard. The method 285 further includes receiving, by the interworking system, a PDN request including an access point name (APN) for a specific network of LTE-M devices, determining a data network name (DNN) corresponding to the APN, and routing the data traffic to an LTE-M network slice based on the determined DNN.

While for purposes of simplicity of explanation, the respective processes are shown and described as a series of blocks in FIGS. 2H-2I, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

In the above-described embodiments, the interworking functions between LTE-M devices and the 5G communication network are described, but the present disclosure is not limited thereto. One or more of the components and/or functions described herein can be utilized with other communication networks which may be next generation or higher generation communication networks than the 5G communication network. Instead of or in addition to LTE-M devices, zero energy devices, which may not require or change a battery, may be used in the 5G communication network and/or higher generation communication networks. IoT devices, which are compatible with 5G and/or higher generation communication networks, may be used in environments where low or zero battery consumption is desirable and low or intermittent data transmission is required.

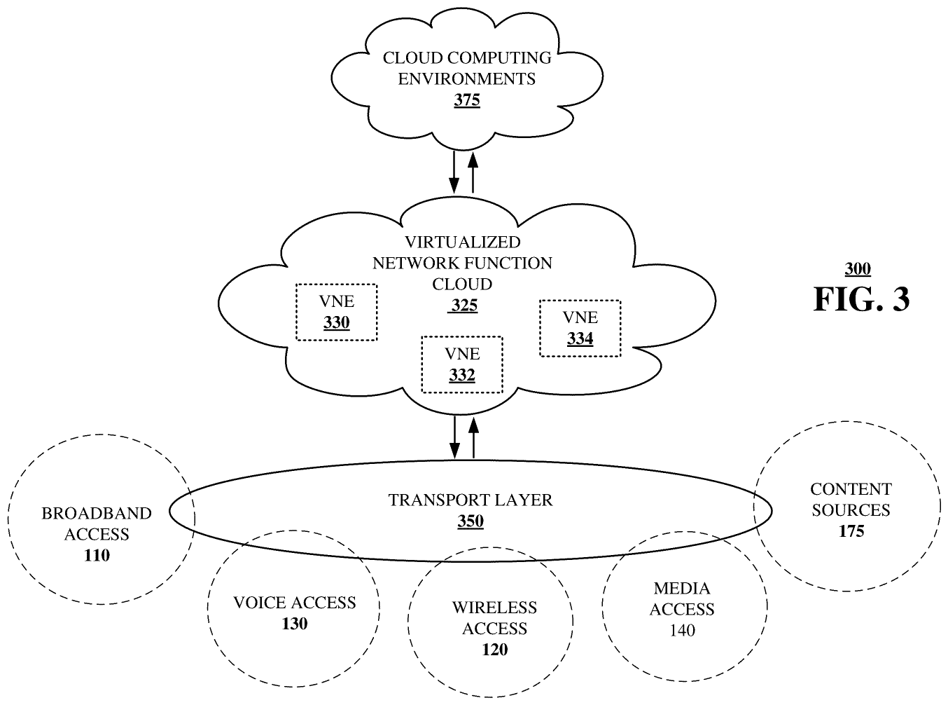

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, 210 and method 230, 280, 285 presented in FIGS. 1, 2A, 2B, and 3. For example, virtualized communication network 300 can facilitate in whole or in part systems and methods facilitating interworking of LTE-M devices with 5G communication networks.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

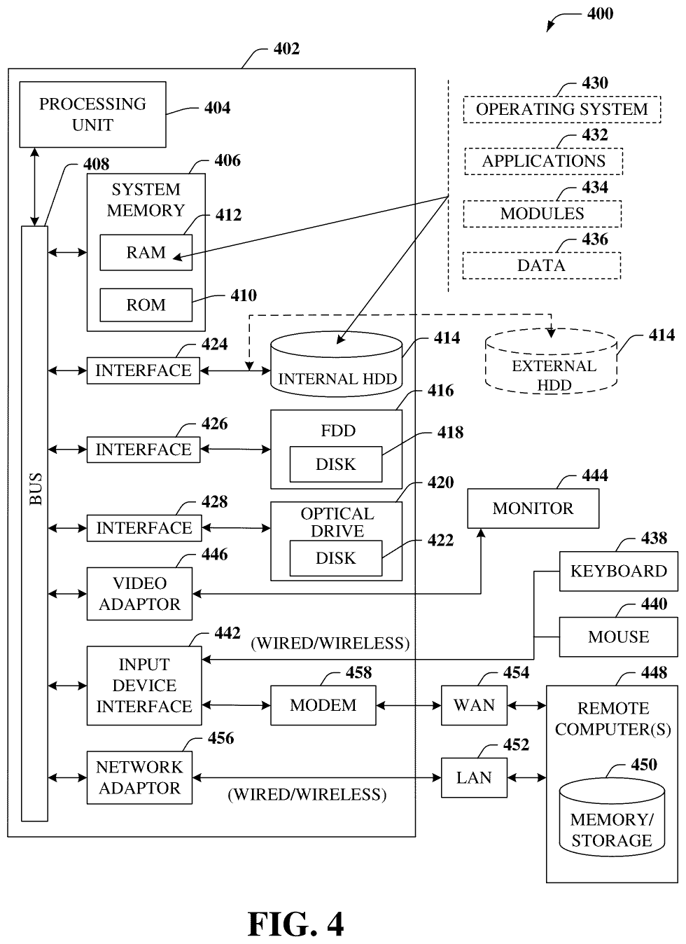

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part systems and methods facilitating interworking of LTE-M devices with 5G communication networks.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

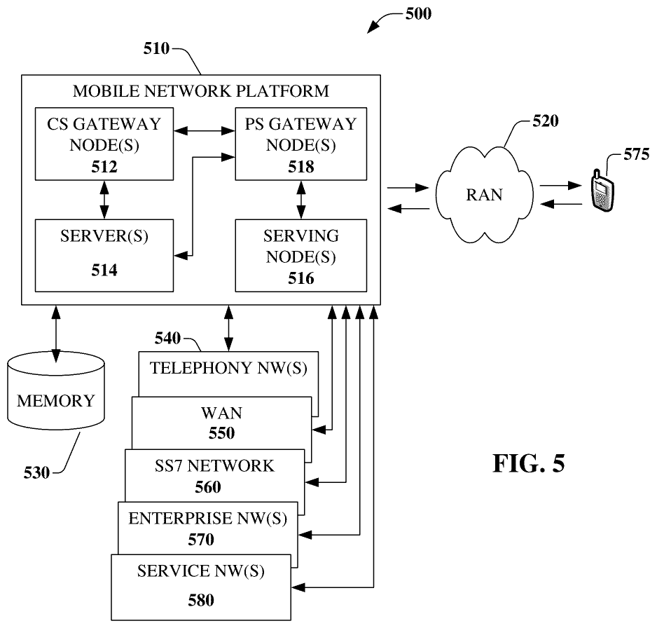

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part systems and methods facilitating interworking of LTE-M devices with 5G communication networks. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

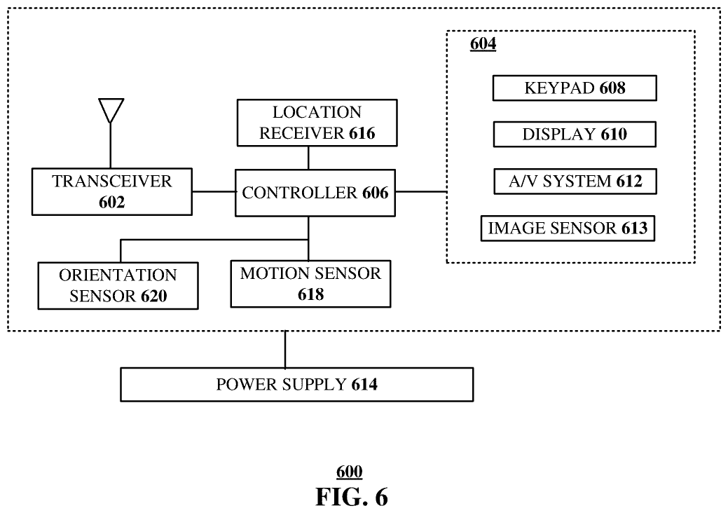

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part systems and methods facilitating interworking of LTE-M devices with 5G communication networks.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
with a first component, connecting an LTE-M device with an access and mobility management function (AMF) of a mobile core of a 5G network over an N-1 interface;
with a second component, connecting an LTE radio with the AMF over a S1 control (S1-MME) interface and a N2 interface using a next generation application protocol (NGAP); and
with a third component, transferring a data traffic from the LTE-M device via a user plane function (UPF) of the 5G network by terminating a packet data network (PDN) session and reestablishing as a packet data unit (PDU) session.

2. The device of claim 1, wherein, with the first component, the connecting the LTE-M device further comprise configuring the first component to emulate a set of functions of a mobility management entity (MME) in communicating with the LTE-M device and emulate another set of functions of the AMF in communicating with the AMF.

3. The device of claim 2, wherein the emulating the set of functions of the MME further comprises sending a registration request including an international mobile subscriber identity (IMSI) of the LTE-M device via non-access stratum (NAS) signaling.

4. The device of claim 3, wherein the emulating another set of functions of the AMF further comprise:
intercepting the registration request and detecting the IMSI of the LTE-M device;
determining a subscription permanent identifier (SUPI) corresponding to the IMSI of the LTE-M device; and
encrypting the SUPI to a subscription concealed identifier (SUCI).

5. The device of claim 1, wherein, with the second component, the connecting the LTE radio with the AMF further comprise configuring the second component to process control signaling transmitted via a set of protocols over the S1 control (S1-MME) interface to be transmitted using another set of protocols including the NGAP over the N2 interface.

6. The device of claim 5, wherein the second component is configured to process the control signaling transmitted via SCTP to be wrapped with the NGAP to be transmitted over the N2 interface.

7. The device of claim 3, wherein, with the third component, the transferring the data traffic further comprise configuring the third component to use a set of protocols over a S1 user data (S1-U) interface including a GTP-U and use another set of protocols including a 5G encapsulation protocol over a N9 interface.

8. The device of claim 7, wherein the operations further comprise, with the third component, querying the first component to obtain a subscription permanent identifier (SUPI) corresponding to the IMSI of the LTE-M device.

9. The device of claim 7, wherein the configuring the third component further comprise configuring the third component to terminate a GTP-U session and reestablish a packet data unit (PDU) session.

10. A non-transitory machine-readable medium, comprising executable instructions that, when executed by a processing system including a processor, facilitate performance of operations, the operations comprising:
connecting, via a first component, an LTE-M device with an access and mobility management function (AMF) of a mobile core of a 5G network over an N-1 interface;
connecting, via a second component, an LTE radio with the AMF over a S1 interface and a N2 interface using a next generation application protocol (NGAP); and
transferring, via a third component, a data traffic from the LTE-M device via a user plane function (UPF) of the 5G network by terminating a packet data network (PDN) session and reestablishing as a packet data unit (PDU) session.

11. The non-transitory machine-readable medium of claim 10, wherein the connecting, via the first component, further comprise configuring the first component to emulate a first set of MME functions between the LTE-M device and the first component and emulate a first set of AMF functions between the first component and the AMF.

12. The non-transitory machine-readable medium of claim 11, wherein the connecting, via the second component, further comprise configuring the second component to emulate a second set of MME functions between the LTE radio and the second component and emulate a second set of AMF functions between the second component and the AMF.

13. The non-transitory machine-readable medium of claim 12, wherein the connecting, via the third component, further comprise configuring the third component to emulate a set of serving gateway (SGW) functions between the LTE radio and the third component and emulate a set of user plane functions between the third component and the UPF.

14. A method, comprising:
connecting, by an interworking system including a processor, an LTE-M device with an access and mobility management function (AMF) of a mobile core of a 5G network over an N-1 interface;
connecting, by the interworking system, an LTE radio with the AMF over a S1 interface and a N2 interface using a next generation application protocol (NGAP); and
transferring, by the interworking system, a data traffic from the LTE-M device via a user plane function of the 5G network by terminating a packet data network (PDN) session and reestablishing as a packet data unit (PDU) session.

15. The method of claim 14, wherein the connecting the LTE-M device with the AMF further comprises:
receiving a registration message from a LTE-M device over an N1 interface; and
intercepting the registration message and detecting an international mobile subscriber identity (IMSI) identifier of the LTE-M device.

16. The method of claim 15, wherein the connecting the LTE-M device with the AMF further comprises:
determining a subscription permanent identifier (SUPI) corresponding to the IMSI identifier of the LTE-M device; and
encrypting the SUPI to a subscription concealed identifier (SUCI).

17. The method of claim 14, wherein the connecting the LTE radio with the AMF further comprises:
wrapping a stream control transmission protocol packet with the NGAP; and
transmitting the NGAP wrapped packet over the N2 interface.

18. The method of claim 14, wherein the transferring the data traffic further comprises:
receiving the data traffic encapsulated by a GTP packet in the PDN session prior to the termination.

19. The method of claim 18, wherein the transferring the data traffic further comprises:
in the reestablished PDU session, transmitting the data traffic encapsulated according to a 5G standard.

20. The method of claim 14, further comprising:
receiving, by the interworking system, a PDN request including an access point name (APN) for a specific network of LTE-M devices;
determining a data network name (DNN) corresponding to the APN; and
routing the data traffic to an LTE-M network slice based on the determined DNN.
